(19) United States
(12) Patent Application Publication
(10) Pub. No.: US 2015/0325940 A1
(43) Pub. Date: Nov. 12, 2015

(54) PROTECTING CONNECTOR COVER WITH ATTACHING MEANS

(71) Applicant: Knut Foseide, Oslo (NO)

(72) Inventor: Knut Foseide, Oslo (NO)

(21) Appl. No.: 14/408,944

(22) PCT Filed: Jun. 19, 2013
(86) PCT No.: PCT/NO2013/050112

§ 371 Date: Dec. 17, 2014

(30) Foreign Application Priority Data
Jun. 19, 2012 (NO) 20120709

(51) Int. Cl. H01R 13/447; H01R 13/639; H01R 13/66

(52) U.S. Cl. CPC H01R 13/447; H01R 13/6691; H01R 13/639

(57) ABSTRACT

A protecting connector cover with an attaching means adapted for attaching the protecting connector cover movably to a connector means capable of making an electric connection with an electronic device and having a device for securing or locking the connection with a first operating means for unsecuring or unlocking the connection. The protecting connector cover is movable between a first position and a securable, predetermined second position, comprises at least part of a cover securing means being adapted to secure the protecting connector cover to the connector means in the predetermined second position, and is adapted to uncover and allow access to the first operating means when in the first position and to cover and block access to the first operating means when secured by the cover securing means in the predetermined locked position.

### FIELD OF THE INVENTION

The invention relates to the field of theft prevention or deterrent, and more particularly to a cap, bonnet, cover, or lid type means adapted to provide blocking or warning of an authorised attampt to gain access to a securing or locking device adapted for securing or locking a connection to an electronic device provided by a connector means.

### BACKGROUND

Arrangements for theft prevention in relation to a device for connecting to an electronic device and for securing or locking the connection has been disclosed by K. Foseide in WO02/097754 and U.S.2005/0174238A1.

An anti-theft system and method disclosed by W. T. Kim in U.S.2005/0083200A1 is based on a USB port connecable device and a sybsystem causing an audible alarm triggered by a signal generated within the device.

A method for protecting and an anti-theft device for a computer disclosed by H. Hamaguchi et. al. in U.S.2005/0033546A1 is based on a device body comprising an acceleration sensor configured to detect impact, a detection processing unit configured to output a signal on a detected impact, and an indicator for providing an indication according to the signal.

### OBJECT OF THE INVENTION

It is among the objects of the invention to improve or enhance blocking or warning of an unauthorised attempt to gain access to or manipulate a device for connecting to an electronic device, and to provide a long needed solution for theft prevention that enables physical prevention as well as alarming of unauthorized attampts to open or in other ways manipulate or access an already existing theft preventing locking or securing device.

### SUMMARY OF THE INVENTION

The present invention provides a movable connector cover according to the accompanying patent claim 1.

Further features of the movable connector cover of the invention are recited in the accompanying dependent patent claims 2-5.

The present invention relates to a cover device adapted to cover and restrict acess to an attachment securing means or locking means for attaching securely or locking a connector means to an electronic apparatus, such as e.g. a TV set, a pearsonal computer, PC, audio equipment, or video equipment such as a visual display unit, VDU, or a video projector. The attachment securing means or locking means for which the cover device of the invention is adapted to cover may be one that is attached to or part of an electrical connector. One example of such an attachment securing means or locking means are the securing screws that are commonly included with a plug VGA for connecting to a VGA socket of a PC or a VDU, or with a D-SUB type plug for connecting to a RS-232 data interface socket of a computer or a peripheral device such as a printer or a modem, or or with a stans\dardised DVI type plug for connecting to a digital video interface socket of a computer, video game console, TV set, or video player or recorder, Other examples of such an attachment securing means or locking means is the resilient securing tab that is commonly included with or part of a RJ-45 data network plug, and the Kensington-lock of the standardized Kensington-port.

According to a further aspect, the cover device of the invention is configured or adapted to cover and restrict acess to an attachment securing means or locking means provided with or forming part of a receptacle or a port that is configured or adapted to receive and to secure or lock in place a mating plug for making a connection.

According to a further aspect, the cover device of the invention comprises a cover device securing or locking means adapted to be unsecured or unlocked by a corresponding unsecuring or unlocking device, cover device securing or locking means being configured or adapted to secure or lock the cover device in place such that the securing or locking means of the plug or the receptacle or port becomes inaccessible to unauthorized personnel who is not provided with the proper cover device unsecuring or unlocking means.

According to a further aspect, a cover device securing or locking means comprised in the cover device of the invention is a securing or locking screw which passes through an opening or holde in a suitable part of the cover device. It is contemplated for the screw to form part of or interacct with an electronic alarm device or alarm trigger device, or that instead of the screw, a locking pin that is manouverd and operated by an associated electric solenoid or a press or push magnet, As an alternative to the locking screw or the previously described locking pin manouvering and operating means, it is contemplated to provide the cover device of the invention with a traditional mechanical key operated lock for manouvering and operating the locking pin.

According to a further aspect, the cover device of the invention comprises a receiver for a local or global navigation system, such as for example a GPS receiver, or other similar means for determining a position or device tracking, and a means for transmitting position or tracking information to an externally located device.

According to a further aspect, the cover device of the invention comprises a detector adapted to detect disconnectioin of an associated plug device or socket or port device, or a motion or acceleration detector means, adapted to produce an audible alarm or other type of alarm signal on detection of a disconnection, on detection of or a movement or acceleratoni that exceeds a preset threshold.

### DETAILED DESCRIPTION

In the following, the invenmtion will be described by way of example and with reference to the accompanying drawings, in which

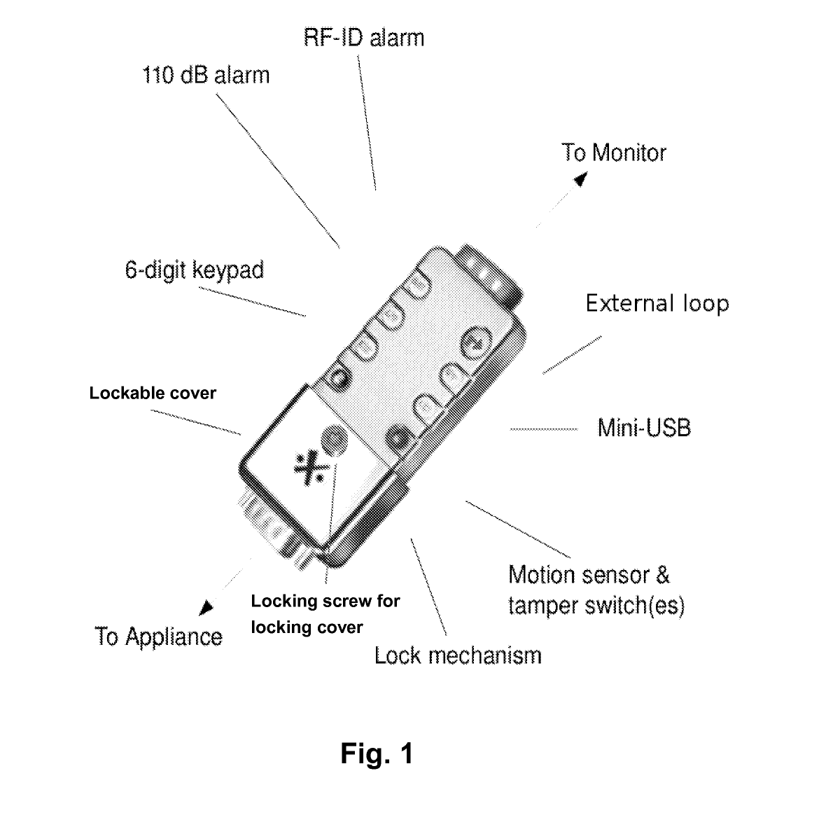

FIG. 1 is a perspective view drawing of a “smart” plug provided with an example of a cover device according to an embodiment of the invention;

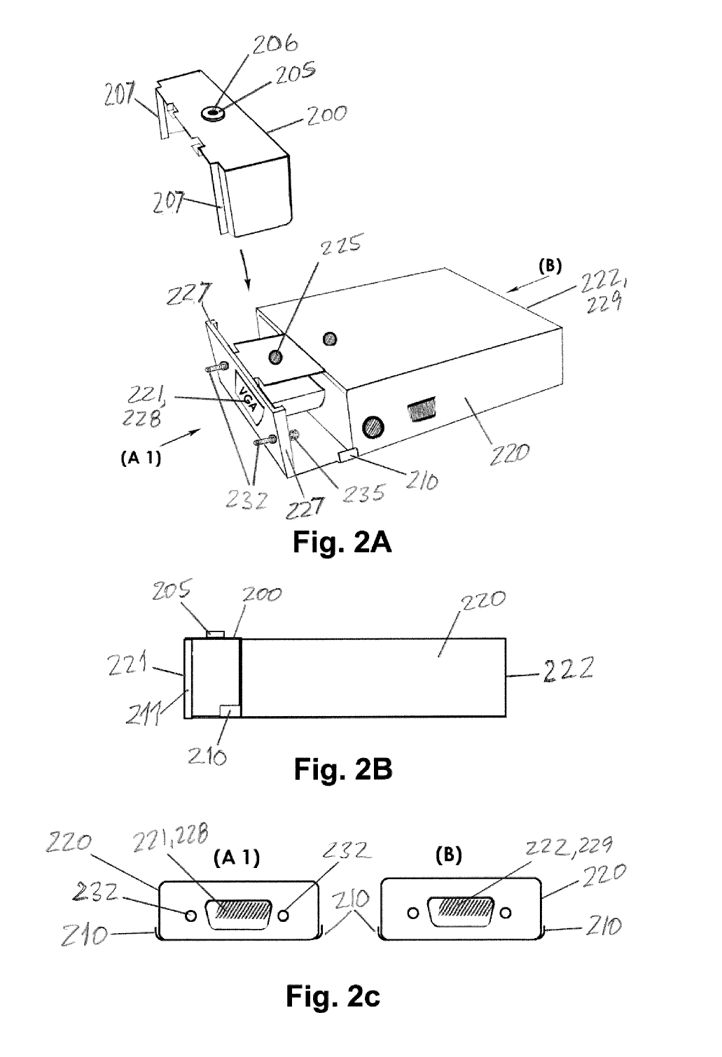

FIG. 2A is a perspective view split drawing of a “smart” plug embodiment and a cover device embodiment example according to the invention separated from the “smart” plug for which it has been configured and adapted;

FIG. 2B is a side view drawing of an assembly of the “smart” plug embodiment and the cover device embodiment example which has been shown separately in FIG. 2A;

FIG. 2C are end view drawings of the “smart” plug embodiment of FIG. 2A;

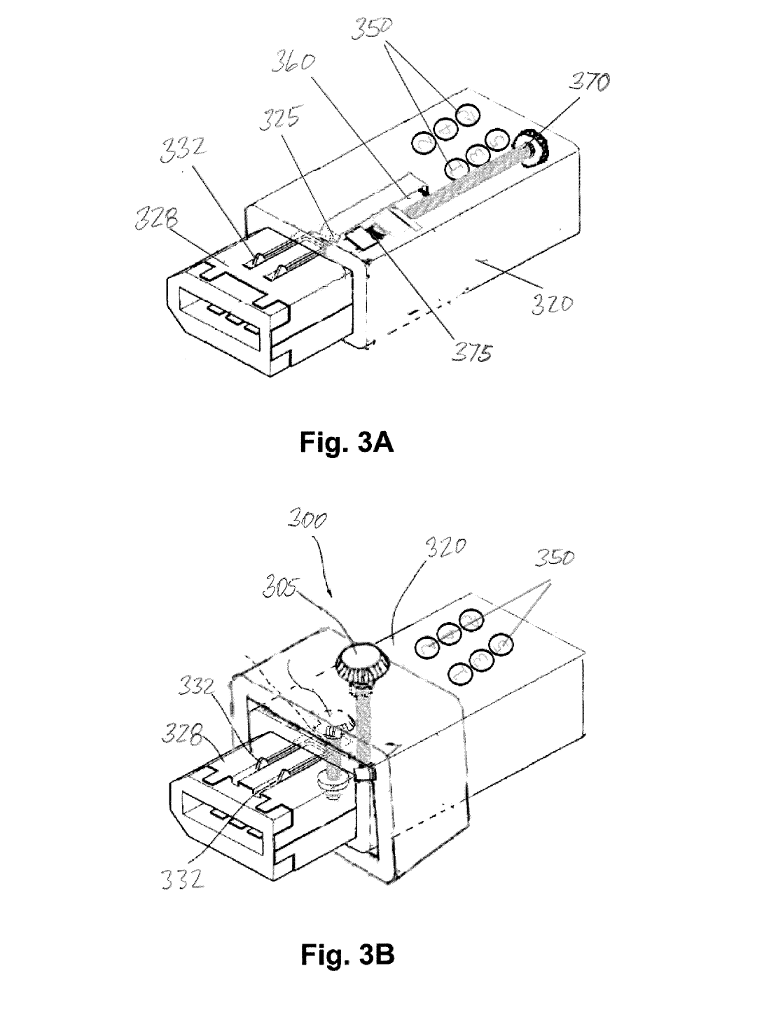

FIG. 3A is a perspective view drawing of a further “smart” plug embodiment;

FIG. 3B is a perspective view drawing of the further “smart” plug embodiment of FIG. 3A and a properly configured and adapted further cover device embodiment according to the present invention fitted over the further “smart” plug embodiment of FIG. 3A;

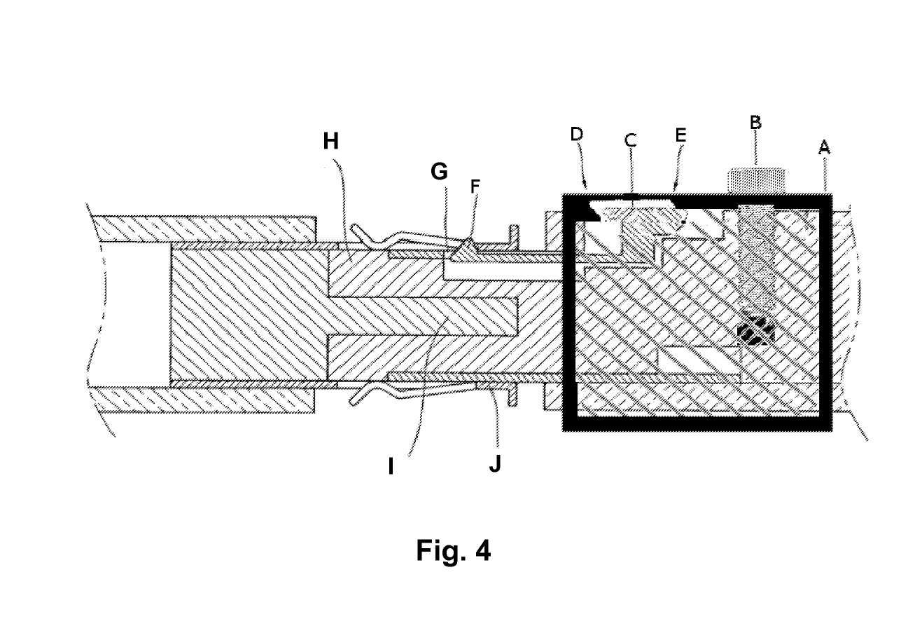

FIG. 4 is a partial cross section view of a connector assembled with a mating connector forming an electrical connection, and a cover device embodiment example according to the present invention fitted over the assembly,

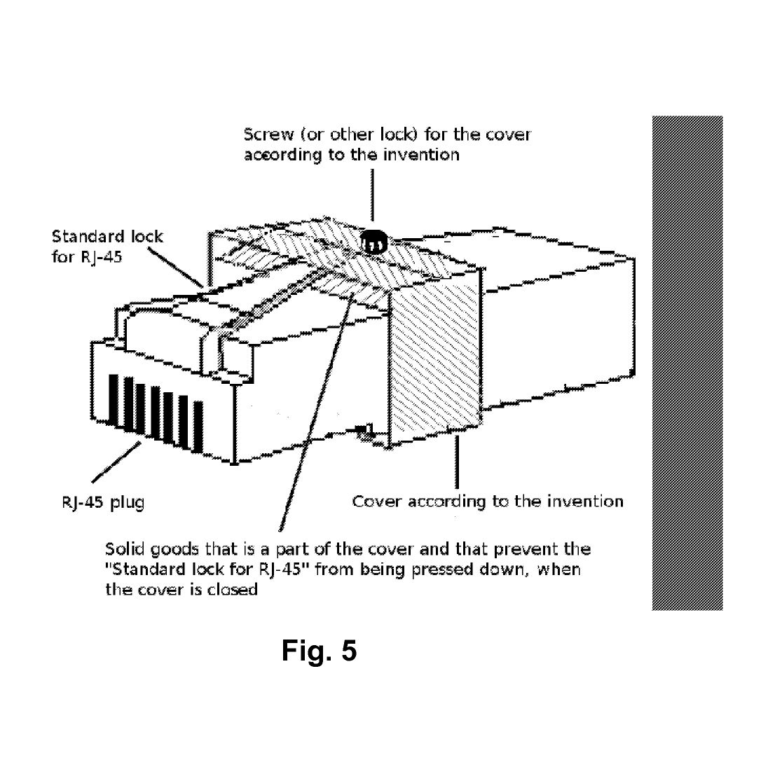

FIG. 5 is a perspective view drawing illustrating a RJ-45 type connector fitted with a further embodiment example of a cover device according to the present invention, wherein this further embodiment example is fitted over the RJ-45 type connector;

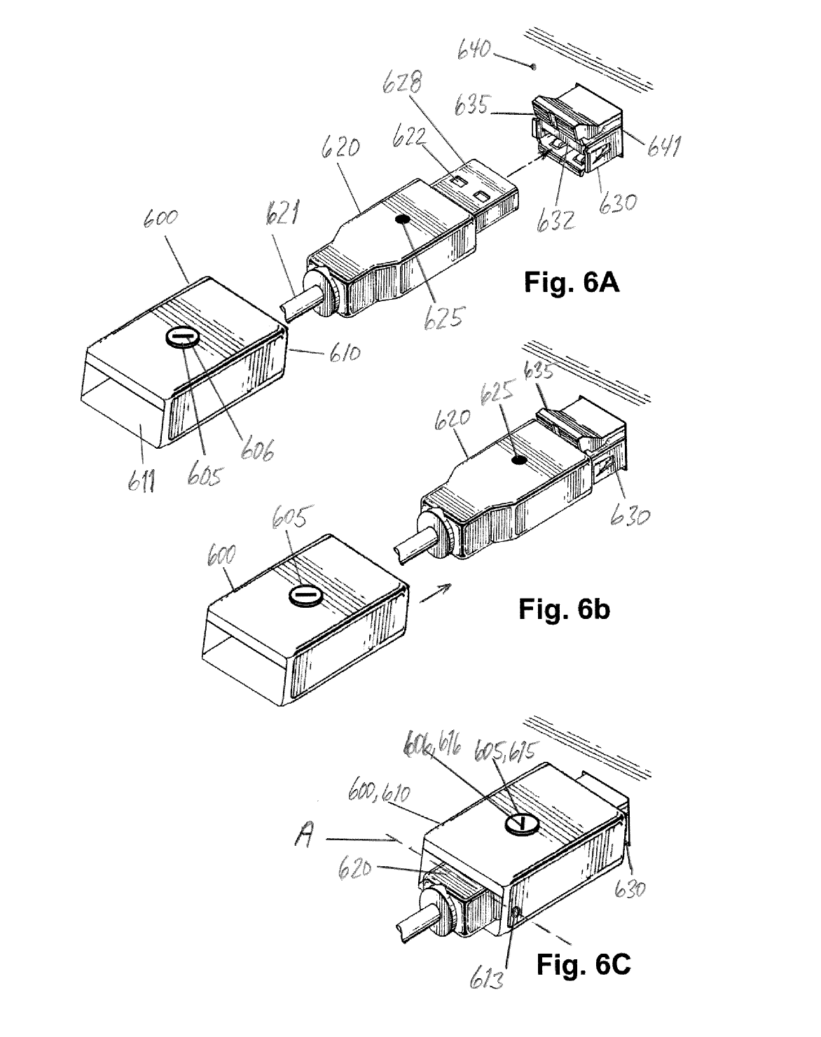

FIG. 6A, 6B and 6C are perspective view drawings of parts of a USB type connection, and lements of a USB connection secured or locked by a further example of an embodiment of the cover device of the invention, and illustrating stages of forming the connection by two mating USB connectors, and securing or locking the connection by the illustrated further example of an embodiment of the cover device of the invention.

In the context of the present invention, the term “cover device” is used for any cap, bonnet, cover, or lid type device that is contemplated or is useful for embodying the invention as disclosed herein.

According to a first example of an embodiment of the invention, illustrated in FIG. 1, the cover device of he invention is adapted for a “smart” plug.

According to a first example of an embodiment of the invention, illustrated in FIG. 1, the cover device of the invention is adapted for a “smart” VGA plug adapter for estalishing a theft proof connection between a first electronic device having a VGA output interface and a second electronic device having a VGA input interface. The “smart” VGA adapter includes a 100 dB audible alarm, and electronic circuitry for detecting disconnection and attempts to disconnect the adapter from connected devices and activating the alarm when any of said disconnection and attempts to disconnect is detected. Said circuitry includes an interface to the locking screw or locking pin for the cover device, for detecting unauthorized manipulation or operation of the locking screw or locking pin, and for activating the alarm when any of said unauthorized manipulation or operation of the locking screw or locking pin is detected

Mechanical construction of the “smart” VGA adapter is based on a metal housing. The housing shall preferably include a hole for the antenna and an oblong hole for a flat cable of a foil keyboard located immediately inside a side panel of the metal housing. The “smart” plug is connected via a D-SUB type 15 pin connector to a VGA output of a protected device. An internal accumulator battery is advantageously charged from a 5V output pin of the VGA output. The “smart” plug includes the security unit which shall be composed from charging electronics, 5 electrical momentary switch buttons provided by the foil keyboard for a deactivation code input and a confirmation button realized by the foil keyboard, a blue LED lamp to indicate the unit state, a piezo buzzer, an RF transceiver, an accelerometer as a motion alarm sensor and a backup Li-Po accumulator battery for ensuring function of the device at least for 48 hours without the external power supply. For connection of an external security loop the unit includes a USB mini type connector. A behavior of the “smart” plug is based on the SafetyCable TM behavior. The accelerometer and RF module extend the “smart” plug capabilities, in that the RF module communicates to a “smart” central (be specified later) if the “smart” central is a part of the solution. After inserting the plug into the VGA connector, it starts configuration and battery charging process. The “smart” plug secures the device at once and has to be deactivated by the password. 5 VDC from the USB power source can also be available from the mini USB connector.

In the following, various examples of events and corresponding responses of the “smart” plug are explained.

Beep events:
slow move of the device
vibration depends on the sensitivity level settings

Alarms activation event:
fast move of the device
position change
remove external loop
remove internal loop

In the following, various examples of disconnect or motion detection means of the “smart” plug are explained.

One Internal Normally Closed (N.C.) loop for theft detection by loop (pin 5,10 or shield on the plug)

One Internal Normally Closed (N.C.) loop for theft detection by accelerometer

One External loop (N.C.) (mini USB plug) for theft detection of peripheral devices

In the following, various examples of communication means of the “smart” plug are explained.

RF communication description:

When the RF-com (radio fequency communication) module is used in the “smart” plug, the RF configuration must be done manually by the user. The user is responsible for the proper ID negotiation with a “smart” central adapted to communicate with the “smart” plug.. This is advantageously be done by buttons and LED lamp signaling on both sides. The “smart” plug is typically configured by default to send status of the “smart” plug every 500 seconds to the associated receiving “smart” central.

By the status here is meant:
Check the cable presence in the network
Battery status
Power supply status

The alarm is sent immediately to the “smart” central when it occurred.
All alarms mentioned above

All RF communication must be acknowledged be the “smart” central.
Compatibility: “smart” central, SafetyCable

Specification
Housing Metal
Dimensions Internal dimensions 50×32.6×19.6 mm
Supply voltage DC 5 V ±10% from VGA output
Supply current <300 mA
Operating time from battery >48 hours
Communication interface for RF, frequency band 868 MHz
External security loop 2 wire current loop, USB mini type connector
Antenna Depend on the material of the housing
Indicators 1 or 2 status LED, piezo buzzer

A further embodiment of a “smart” VGA plug adapter and a therefor suitably formed cover device according to the invention are illustrated in FIGS. 2A, 2B and 2C, and will be explained in more detail in the following with references to these illustrations. This further embodiment of a “smart” VGA plug adapter comprises a main body or main housing 220, having attachment or securing means in the form of securing screws 232 for attaching or securing it to a mating VGA connector element to form a VGA signal connection. The securing screws 232 are operated by large and typically cylindrical screw heads that allow operation by fingers of a human or a suitable tool for rotating the screws for engaging the threads of the screws in a corresponding threaded part of a mating unit. The screw heads 235 are located in an area of the main body or main housing 220 that is open to the surroundings and provides a user with unrestricted access to them from the outside for forming a secured connection and for unsecuring the conenction and break the connection by removing the “smart” VGA plug adapter from the unit with which it is forming the connection. The elctrical connection in the area of interest with respect to the present invention is the area viewed and illustrated in FIG. 2C that is indicated by marking “A1”. For the details of that view, reference signs 221 and 228 are for the male or female VGA conenctor alternatives, respectively.

The cover device 200 is formed with back folded side edges 207 that fit behind matching 90 degree folded edge parts 227, 211 of the main body or main housing 220 of the “smart” VGA plug adapter. The cover device 200 includes a locking screw or other locking means, which could form a first part of a cover device secruring or locking means, advantageously adapted to co-operate or match with a corresponding or receiving securing or locking part 225 of the the main body or main housing 220. The cover device 200 is formed with a “skirt” that fits behind a tab 210 of the main body or main housing 220, to deter attempts to gain acces to the screw heads by bending up the sides of the cover device that are adjacent of the back folded side edges 207 when the cover dvice has been positioned on the the main body or main housing 220 of the “smart” VGA plug adapter as illustrated in FIG. 2B.

In the following, a further embodiment of the cover device according to the invention configured and adapted for securing or locking a HDMI connection is explained with reference to the illustration of the accompanying FIGS. 3A and 3B.

The “smart” HDMI connector 320 embodiment example illustrated in FIG. 3A comprises a main body and a contact prong 328. Advantageously, the contact prong 328 includes a connection secruing or locking means in the form of pins or hooks 332 extending beyond a surface of the prong, and which are retractable by way of a retraction mechanism 325. The retraction mechanism could electrical, and operated or controlled by way of electronic circuitry 360 contained in the “smart” HDMI connector 320, or be operated manually by an operating means provided on or in the “smart” HDMI connector 320 at a part of the connector that is suitable to be fitted with a cover device according to the present invention. Like the “smart” VGA connector adapter illustrated in FIG. 1, the exemplary “smart” HDMI connector 320 embodiment illustrated for explaining the invention could be provided with a six (or more, or less) digit keypad 350 for entering a security code or other inputs to configure or lock and secure an HDMI connection made with the the “smart” HDMI connector 320.

Reference is made to FIG. 3B, showing by way of example an embodiment of the cover device of the invention 300, fitted in a locking position on the “smart” HDMI connector 320, adapted for securing or locking an HDMI connection made with the “smart” HDMI connector 320 an a mating HDMI connector (not shown) that is adapted to receive and cooperated with the connection secruing or locking means in the form of pins or hooks 332 included in the contact prong 328. This exemplary cover device according to the invention constitutes a typically rectangular “shell” formed to be slidable over the main body of the “smart” HDMI connector 320, and includes a locking screw 305 that fits in a receiving counterpart provided in the “smart” HDMI connector 320. Advantageously is the receiving adapted to include or allow the locking screw 305 to co-operate with a tamper detector in the “smart” HDMI connector 320.

Reference is made to FIG. 4, showing by way of example a cross ection of the above explained embodiment of the cover device of the invention 300, and also showing parts of a mating connector counterpart, which are a prong part “I” of a gender that is opposite to the gender of the prong part 328 of the mating connector counterpart. In FIG. 4, reference “J” points to the part that comprises the arrangement G that receives and locks in place the pins or hooks “F”, also shown by 332 in FIGS. 3A and 3B. “A” corresponds to locking cover device 300, “C” is a securing or locking lever or tab provided by certain variants of standardized HDMI connectors to manually operate the the pins or hooks “F” for releasing a locked or secured connection and herein covered and concealed by a down angled or down folded edge part “D” of the cover device “A” according to the invention.

In the following, a further embodiment of the cover device according to the invention configured and adapted for securing or locking a connection made with a RJ-45 type connector is explained with reference to the illustration of the accompanying FIG. 5. Similar to what has been explained above for the mebodiment of the cover device according to the invention that is adapted for the HDMI connection means illustrated in FIG. 3B, is the the embodiment of the cover device according to the invention generally constituted by a hollow cylinder of generally rectangular cross section that is slidable over the RJ-45 type connector and lockable in place to cover and restrict access to the usual securing or locking tab or lever of the RJ-45 type connector.

In the following, a further embodiment 600 of the cover device according to the invention configured and adapted for securing or locking a USB connection is explained with reference to the illustrations provided by the accompanying FIGS. 6A, 6B, and 6C. In this embodiment 600, the cover device of the invention is adapted to secure and block access to an attaching, securing or locking means 635 of a USB connector. The attaching, securing or locking means 635 of a mating USB connector 630 or of the USB connector 620 itself, could be key operated or in other ways furnished with means for allowing only authorized personnel access to operate or manipulate the attaching, securing or locking means of the USB connector. In this embodiment, the cover device of the invention is constituted by a metal box with “open ends”, that is, a hollow cylinder of generally rectangular cross section that is slidable to be applied to and over the USB plug and shaped to extend forward in the connection area to cover and conceal the attaching, securing or locking means of the USB connector. In an alternative embodiment, the cover device embodiment 610 according to the invention comprises a main body part formed by the connector 620 and a hinged part 610, the hinged part constituting a further cover or lid that is lockable to the main body of the cover device. Hinging 613 is provided to rotate about an axis “A” illustrated in FIG. 6C. Locking means 605 is adapted to cooperate with a receving arrangement 625 in the connector 620, and lock means 606 is provided to allow only personell authorized and equipped with suitable key to operate the locking means 606 to unlock or unsecure the cover device from the connector 620. Although this embodiment has been disclosed in connection with a USB connector, it could suitably be adapted for securing a connection made by the RJ-45 type connector that is typically used for connecting electronic data equipment to a data network device, as explained in more detail above.

In the following, the cover device of the invention will be explained in connection with a “smart” plug and a “smart” central that is adapted to communicate with the “smart” plug.

The “smart” central is a wireless alarm router that continously maintains a 2-way “handshake” RF communication with each “smart” plug or SafetyCable TM in the area it is located. When it receives an alarm signal from a Xpres product it forwards this to any commercial alarm- or access control system. The output of an XSC-500 type “smart” central is a normally closed circuit that opens upon alarm. The router has option for user defined resistors at its alarm output. This enables a user to obtain an even higher level of security when connecting Xpres products to a professional alarm or access control system. You may employ one unit of the “smart” central only to cover as many as 100“smart” plugs and/or SafetyCables. May feature a GSM-module that forwards any alarm by SMS-message to a mobile phone number of your choice. The “smart” central is then a stand-alone alarm central that is all you need for wireless surveillance of The “smart” plug or SafetyCable.

Mechanical construction is based on a purchased plastic box that can be table placed or wall mounted similar to e.g. wi-fi router. On the back side of the box there are placed antenna connectors, power supply inlet and relay contact outputs. The “smart” central includes the supervisory unit which shall be composed from charging electronics, a binding button, LED lamp indication of the unit state, a piezo buzzer, an RF transceiver, an accelerometer as a motion alarm sensor and a backup Li-Pol battery accumulator ensuring function of the device at least for 48 hours without the external power supply. The output is a relay normally closed contact. After power up the device starts configuration of the RF network and battery charging.

The “smart” central below mentioned states:

Warning events (change LED status or beep):
Power off (LED blinking—beep)
Battery almost gone (LED blinking—RED Color—beep)
Missed cable, RF signal is not present (LED blinking)
Cable or Plug battery is low

Alarms activation event (close or open relay contacts):
receive valid alarm from the Cable or Plug
break tamper
battery is gone (could be discussed later)

RF communication description:

The “smart” central communicates with the RF modules placed in SafetyCable and The “smart” plug and receive all the status of the devices and alarms. The network configuration and ID negotiation must be done manually by the user. The user is responsible for the proper ID negotiation with all the devices in the network. This could be done by buttons and LED signaling on both sides. The integrated GSM module sends SMS when an alarm is active. The “smart” central can also deactivate, activate and control all other functionality of the products it is connected to with RF-signals. The

The “smart” plug/ SafetyCable can send all information it has stored to the “smart” central by RF-signal. Compatibility: SafetyCable TM, and the “smart” plug

Specification
Housing Plastic box that can be placed on a table or wall mounted
Dimensions Internal dimensions 47×34×19 mm

Supply voltage DC 5 V ±10% from external adapter

Supply current <1 A
Operating time from battery >48 hours
Communication interface RF, frequency band 868 MHz
100 SafetyCables and The “smart” plug devices can be connected to one “smart” central simultaneously,
GSM module
Output 2 wire current loop NC contact, balanced loop with user's resistor (separate connectors for resistor and wires)
Antenna External
Indicators status LEDs, small piezo buzzer

Advantages.

The invention provides a security enhancement of existing types of connections, in particular connectors that fit different types of electrical or electronic devices. In the form of a box made of a strong material, such as a hard or strong metal, or a combined with or as an integral part of a bracket or intermediary part, the cover device of the invention is provided with means for attaching it, or hinging it to a plug, a receptacle, a port, or a similar device, so as to effectively cover or conceal an attaching or locking means of the plug, receptacle, port, or similar device that has been provided for or is part of the plug, receptacle, port, or similar device, that is adapted for attaching or locking it to a mating plug, receptacle, or port, or similar mating device. Thereby, the cover device of the invention effectively blocks for unauthorized access to the device for attaching, and eliminates or deters unauthorized disconnection and theft of an element that forms part of the connection

1. A protecting connector cover with an attaching means adapted for attaching the protecting connector cover movably to a connector means capable of making an electric connection with an electronic device and having a device for securing or locking the connection with a first operating means for unsecuring or unlocking the connection,
wherein the protecting connector cover is movable between a first position and a securable, predetermined second position,
the protecting connector cover comprises at least part of a cover securing means being adapted to secure the protecting connector cover to the connector means in the predetermined second position, and
the protecting connector cover being adapted to uncover and allow access to the first operating means when in the first position and to cover and block access to the first operating means when secured by the cover securing means in the predetermined locked position.

2. The protecting connector cover of claim 1, wherein the cover securing means comprises at least part of a key operated locking means being adapted to lock the protecting connector cover to the connector means in the predetermined second position.

3. The protecting connector cover of claim 1, wherein the cover securing means comprises a lockless and releasable securing device.

4. The protecting connector cover of claim 1, wherein the cover securing means is a releasable securing means and comprises a part adapted to cooperate with a release detector for detecting a release of the releasable securing means.

5. The protecting connector cover of claim 4, wherein the part adapted to co-operate with a release detector is adapted to trigger a release detection event and a subsequent generation of an alarm signal or a signalling of a release signal by at least one of an alarming device and a signalling device.
